(19) United States
(12) Patent Application Publication
(10) Pub. No.: US 2012/0138730 A1
(43) Pub. Date: Jun. 7, 2012

(54) STABILIZED SAFETY GYROPLANE

(76) Inventors: Claude Annie Perrichon, d'Abeau (FR); Francois Giry, Challes les Eaux (FR); Pierre Piccaluga, Prangins (CH); José Buendia, Bourgoin Jallieu (FR)

(21) Appl. No.: 13/390,276

(22) PCT Filed: Aug. 20, 2009
(86) PCT No.: PCT/FR09/01017

§ 371 Date: Feb. 13, 2012

(30) Foreign Application Priority Data
Aug. 14, 2009 (FR) FR2009/001006

(51) Int. Cl. B64C 27/02

(52) U.S. Cl. 244/17.13; 244/17.21

(57) ABSTRACT

The rotary wing aircraft is based on the principle of the gyroplane, and includes a double wing rotating in opposite directions, coupled to a power converter which transfers the power of the gyroplane engine for launching by a mechanical converter which provides the lift energy and which, under command from the airframe, transposes the power to the horizontal thrust propeller. The aircraft is put into natural lift mode by its translational speed, this operating principle allowing take-off at low wind speeds which do not allow auto-rotation to be established.

### FIELD OF THE INVENTION

The field of the present invention relates to air transportation.

### BACKGROUND OF THE INVENTION

The ideal form of transport for all travelers in the future remains unknown, in view of the problems of consumption, pollution and safety. The consideration of various approaches which, together with the restriction of traffic, may lead to a faster, more efficient approach which requires greater attention to safety.

Travel is essential for active people involved in the marketing of real services as well as virtual ones, requiring a degree of reactivity and entailing delays in transactions and decision-making because of speed restrictions. The gyroplane is a special type of aircraft which requires further development, in general terms, in the interests of flight safety and environmental protection. Various factors relating to noise and pollution may lead to a preference for overland travel or low-cost transport. Safety is the main factor that may lead to consideration of the problems of aircraft, which land at high speeds at specific locations. Helicopters are highly expensive and noisy, and their safety rating is a source of concern, owing to the rotor blades which are subjected to different inclinations by a set of cranks in each rotation.

### SUMMARY OF THE INVENTION

The present application considers different processes which are combined to provide for the integration of a double rotary wing which is coupled to a launching engine in such a way that the counter-torque rotor, which creates a high degree of risk, can be dispensed with. This device is used until the natural lift effect is sufficient. In the present arrangement, various technologies are combined with the principle of gyroplane technology represented by eCRT technology which provides additional safety.

### BRIEF DESCRIPTION OF THE DRAWING(S)

FIG. 1 is a schematic drawing illustrating a side view of an embodiment of a gyroplane in accordance with features of the present invention.

### DETAILED DESCRIPTION OF THE PREFERRED EMBODIMENTS

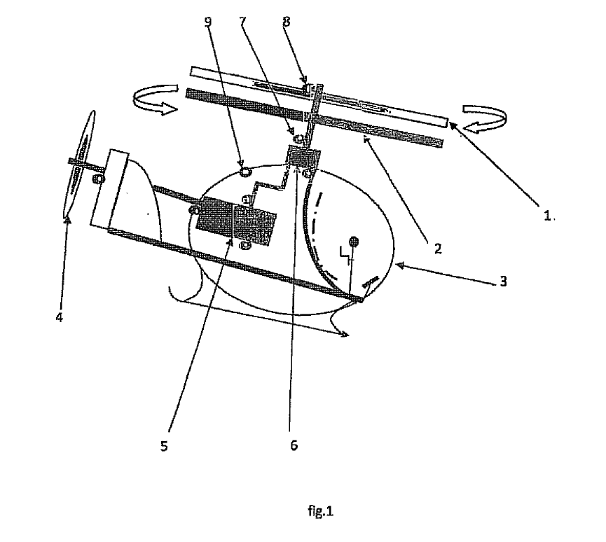

In FIG. 1, a gyroplane is illustrated and composed of two rotors (1, 2) which are rotary wings whose blades rotate in opposite directions to each other to provide an equilibrium of the lift forces without requiring an active counter-torque rotor. For launching the aircraft, the engine (5) starts the rotor blades (1, 2) before lift comes into effect, thus greatly improving the safety of take-off. This device also permits a practically vertical take-off at a low wind speed of less than 20 knots, without damage or loss of equilibrium, or excessive taxiing distance.

The torque converter operated from the pilot's airframe actuates the rotors (1, 2) with opposing mechanical rotation (6) until the autorotation lifts the aircraft. The converter enables the minimum useful energy of the engine (5) to be transmitted in order to provide lift. The engine (5) transfers its power to the horizontal thrust propeller (4), thus creating translational speed and enabling the gyroplane to be moved forwards, while receiving its lift without the need to supply energy to its rotors which support the aircraft (1, 2) naturally.

The blades are at constant pitch, which tends to create drag which reduces flight speed, but provides a considerable degree of safety. The pitch could be variable but identical for both blades constituting the dynamic wing structure, as is the case with the propellers of fixed wing aircraft which have variable-pitch propellers. Clearly, this relates to both rotors (1, 2). The controls provided in the airframe (3) enable the operations for correct flight to be carried out with high visibility. This stability, enhanced by the integration of two rotors forming the rotary wing, provides high stability and, together with the link to the relatively slow-running forward movement engine, provides lift without putting the aircraft into autorotation mode.

This device provides assured safety due to the auto-stabilization of the aircraft during its flight. This characteristic is not the operating conditions or the function but an instantaneous transitory flight safety approach which gyroplanes do not have at present, and which undeniably requires an energy input.

Additionally, the mechanical noise and rotor noise are reduced by the contribution of the eCRT technology which is one of the applications to the mechanical components, in the form of a mechanical flight member linking the engine, the airframe structure, the shafts of the rotors of the rotary wing and the power converter to the blades which are regulated when the aircraft is launched.

The noise gain is at least 5 decibels and the useful power with a conventional piston engine or a Wankel or turbine or other type of engine will be very effective with a horsepower rating of 110 to enable the set of rotors to be started without difficulty. The mechanical friction is greatly reduced, thus providing reliability and a high gain in available power in view of this mechanical arrangement with multiple shafts assisted by the intelligent eCRT technology which regulates the tension and stresses of the mechanical components.

Incorporated by reference in it's entirety, is the patent application PCT/FR 2009/001006 of 14 Aug. 2009. The technology disclosed in this patent application provides noise-free operation and remarkable reliability, while freeing engine torque, and also reduces fuel consumption by 15% to 20% and eliminates more than 35% to 40% of NOx at least.

The eCRT sensors are placed on the shafts and on the airframe (3) of the gyroplane, in the form of eCRT (7; 8; 9) for example, which are adhesive automatic radio control devices detecting all the relative positions which are automatically controlled by “automatic radio control” of the movements of the mechanical components under stress contributing to the movements of the aircraft.

The aerial operation of the machines is highly sensitive and the dynamic wing provides “added lift” because of the eCRT implementation which orders the polarities and the electromagnetic currents which are controlled or eliminated, thus avoiding the drawbacks of electromagnetic incompatibility arising from mechanical stresses, improving the flight performance and freeing the mechanical power without stress. Thus the eCRT sensors eliminate these incidental and opposing fluctuating electromagnetic loads, in stable ideal conditions, without interference and without fluctuating counter-forces, for the flight of an aircraft provided with at least one dynamic rotary wing, in this non-limiting exemplary embodiment.

1. A method for providing safety and stability in a gyroplane by the mechanical integration of a double wing rotating in opposite directions coupled to a launching engine, until the natural lift comes into effect, making it possible to dispense with a counter-torque rotor, and allowing vertical take-off at low wind speeds.

2. The method as claimed in claim 1, further comprising a thrust propeller which enables the gyroplane to be moved forwards and provides lift due to the translation of the gyroplane along the horizontal axis.

3. A rotary wing aircraft based on the principle of the gyroplane, composed of a double wing rotating in opposite directions, coupled to a power converter which transfers the power of the gyroplane engine for launching by a mechanical converter which provides the lift energy and which, under command from the airframe, transposes the power to the horizontal thrust propeller, the aircraft being put into natural lift mode by its translational speed, this operating principle allowing take-off at low wind speeds which do not allow autorotation to be established.

4. The rotary wing aircraft as claimed in claim 3 is assisted by eCRT “radio control” provided by eCRT sensors which smooth out the effects of electromagnetic incompatibility created by the mechanical components under stress, thus improving flight performance and freeing the available power from stress, interference and counter-forces.
